(19) United States
(12) Patent Application Publication
(10) Pub. No.: US 2026/0030069 A1
(43) Pub. Date: Jan. 29, 2026

(54) SYSTEM AND METHOD FOR DISTRIBUTING WORKLOAD IN A COMPUTING ENVIRONMENT

(71) Applicant: Hewlett Packard Enterprise Development LP, Spring, TX (US)

(72) Inventor: David Josef Emir Marchi, San Jose, CA (US)

(21) Appl. No.: 18/783,813

(22) Filed: Jul. 25, 2024

(51) Int. Cl. G06F 9/50

(52) U.S. Cl. CPC G06F 9/505

(57) ABSTRACT

A computer-implemented method can be used for distributing workload in a cloud computing system that includes a number of data sources. Each data source includes one or more queues. A plurality of replicas of a microservice are instantiated. Each replica is configured to process data from the data sources. Each replica receives information regarding a total number of active replicas and an identifier specific to that replica. Each replica determines a starting queue based on the total number of active replicas and the specific identifier. Each replica processes data from its determined starting queue and subsequent queues in a predefined order.

### BACKGROUND

A cloud computing system is a network of remote servers hosted on the Internet to store, manage, and process data, providing on-demand access to a shared pool of configurable computing resources (e.g., networks, servers, storage, applications, and services) that can be rapidly provisioned and released with minimal management effort or service provider interaction. Various operations can be implemented using a microservice architecture. Microservices are organized so that a software application is composed of small independent services that communicate through lightweight protocols.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 depicts a block diagram of a computer-implemented system according to an example implementation;

FIG. 2 depicts a compute resource system according to an example implementation;

FIG. 3 depicts operation of a computer-implemented system according to an example implementation;

FIG. 4 depicts a cloud based system according to an example implementation;

FIG. 5 depicts a flow chart for a computer-implemented method according to an example implementation;

FIG. 6 depicts a flow chart for a computer-implemented method according to another example implementation;

FIG. 7A depicts a block diagram of a computer-implemented system according to an example implementation;

FIG. 7B depicts a block diagram of a computer-implemented system that can utilized the implementation of FIG. 7A; and

FIG. 8 depicts a flow chart for a computer-implemented method according to an example implementation.

### DESCRIPTION

This description provides different examples for implementing different features. Specific examples of components and arrangements are described below to simplify the present disclosure. These are, of course, merely examples and are not intended to be limiting.

Various implementations relate to the operation of microservices. A microservice in a cloud computing system is typically implemented as a lightweight, independently deployable software component that runs in its own process and communicates through, e.g., well-defined, language-agnostic APIs. The microservice is containerized to encapsulate the service along with its dependencies, ensuring consistency across different environments. These containers are then orchestrated and managed using platforms that handle deployment, scaling, and load balancing.

In some implementations, the microservice can be a specific component of the larger unified-eventing platform, handling the delivery aspect of event processing. For example, the microservice retrieves data from a variety of sources, such as databases, APIs, message queues, or other systems generating events. Instead of processing each piece of data individually or in large batches, it handles small groups (micro-batches) of data at a time. After pulling and potentially processing the data, it sends these micro-batches to pre-defined consumer endpoints. These endpoints could be other services, databases, or applications that need this event data.

Multiple copies, i.e., replicas, of the microservice work can operate concurrently. These can be coordinated using an orchestrator that can manage the workload distribution. The orchestrator, however, adds complexity, creates a potential single point of failure, and increases overhead for small batches that are quick to process.

Instead of utilizing an orchestrator, an example implementation proposes a time-based synchronization method. Each replica is aware of how many total replicas are active. They use this information to self-regulate, ensuring each data source is accessed at regular intervals. The replicas maintain a time window for processing where they wait if they finish too quickly or they request more replicas if they're too slow. Data sources are ordered on each replica, but the order is shifted based on the number of active threads and the replica's ID. This ensures each worker has a unique, predictable order of data sources to process.

This implementation has a number of advantages. There is no need for an additional orchestrator thereby reducing complexity and potential points of failure. The technique is designed to ensure that each data source is visited within a certain time period. If a replica fails, the system continues to function, albeit at a slower pace. This technique can be implemented with little overhead because it utilizes information from the existing resource orchestrator (e.g., Kubernetes) without needing an application-specific orchestrator or additional scheduler.

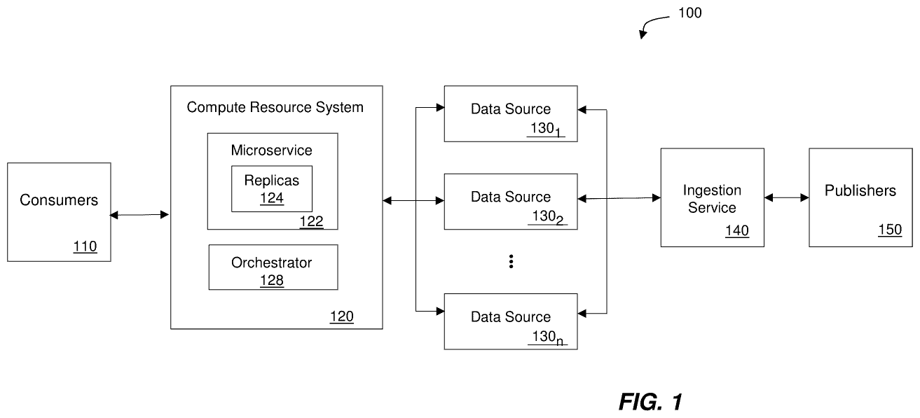

A first implementation will be described with respect to FIG. 1, which illustrates an overview of a computer-implemented system 100 for distributing workload in a cloud computing environment. The system 100 comprises several components that work together to process and deliver events from multiple data sources 130 to various consumers 110.

As but one example, this system can be used for micro-batching. In this implementation, incoming data is grouped into small, manageable batches over short time intervals, typically ranging from a few seconds to a few minutes. These micro-batches are then processed together, allowing for more efficient use of computing resources compared to processing each data point individually, while still providing near-real-time results. For example, the system can be used for real-time analytics, log processing, and event-driven systems.

Referring to FIG. 1, a compute resource system 120, is responsible for executing a plurality of microservices and managing the distribution of workload. The compute resource system 120 includes an orchestrator 128, which manages the allocation of computing resources and oversees the operation of the system components. In this example, the compute resource system 120 is executing a microservice 122, which includes replicas 124. Further detail relating the compute resource system will be provided below.

The system 100 interacts with multiple data sources 130, which can be databases or other storage systems. The figures shows three data sources 130₁, 130₂, and 130ₙ to illustrate that any number of data sources can be utilized. In this implementation, each data source 130 comprises one or more queues that store events or data to be processed. These events or data are typically generated by publishers 150, which determine the distribution of events to appropriate client-specific queues within the data sources 110.

In one example, the data sources 130 can be implemented as a distributed database system, comprising multiple database instances spread across different physical or virtual servers. Each database instance can host multiple client-specific queues, implemented as separate tables or partitions within the database. These queues can be designed to store and retrieve events in a first-in-first-out (FIFO) manner, as an example. The database system can utilize a combination of in-memory and disk-based storage to balance performance and capacity.

An ingestion service 140 is responsible for receiving events from the publishers 150 and distributing them to the appropriate queues in the data sources 110. This service ensures that incoming events are properly routed and stored for processing.

The ingestion service 140 acts as a buffer between the external event generators (e.g., publishers 150) and the internal data storage system 130. The ingestion service 140 can be implemented as a scalable, distributed system capable of handling high volumes of incoming events concurrently. It may employ various techniques such as message queuing, stream processing, or batch processing, depending on the system's requirements and the nature of the incoming data. In various implementations, the service can be designed to perform initial processing on incoming events, which may include validation, formatting, enrichment, and routing based on predefined rules or metadata associated with each event. The service 140 can also implement mechanisms for guaranteed delivery, such as write-ahead logging and acknowledgment protocols.

The publishers 150 represent the various sources of events or data that feed into the system 100. These can be diverse in nature, for example, IoT (internet of things) devices, user applications, backend services, or third-party systems integrated with the platform to name a few. Each publisher 150 is responsible for generating events or data points that are to be processed and ultimately delivered to the appropriate consumers 150. Publishers 150 may operate independently and asynchronously, producing data at varying rates and intervals interacting with the system 100 primarily through the ingestion service 140.

The publishers 150 may implement different protocols or data formats for transmitting events, which the ingestion service 140 is equipped to handle and normalize. To ensure data quality and system integrity, publishers 150 may authenticate and adhere to specific API contracts or data schemas defined by the system. They may also include metadata with each event, such as timestamps, source identifiers, or routing information, to facilitate proper processing and distribution within the system.

The consumers 110 represent the end-point entities in the system 100 that receive and utilize the processed events or data. These consumers can be diverse in nature, ranging from user-facing applications and dashboards to backend systems, analytics engines, or other microservices within a larger ecosystem. Each consumer 110 is typically associated with one or more specific queues within the data sources 130, from which it receives its designated events. The consumers 110 interact with the system primarily through the replicas 124, which deliver the processed events to the appropriate consumer.

Consumers 110 may have varying requirements for data delivery, such as real-time streaming, batch processing, or on-demand fetching. To accommodate these diverse needs, example implementations of the system support different delivery mechanisms and protocols. The consumers 110 may implement callback functions, webhooks, or polling mechanisms to receive data from the system. Additionally, consumers 110 may have the capability to acknowledge receipt of events, enabling the system to ensure reliable delivery and track the progress of event consumption.

In this implementation, the software that implements the processes for the consumers 110 is performed by the replicas 124 that are instantiated by the compute resource system 120. These replicas are multiple instances of a microservice designed to process data from the data sources 110. Each replica is assigned a unique identifier and is aware of the total number of active replicas, information which is provided by the orchestrator 128.

Orchestrator 128 can automate and coordinate the deployment, scaling, and maintenance of the cloud resources and applications. This component can be used as a central control system to oversee the allocation of compute, storage, and network resources across multiple nodes. One example is Kubernetes, which is an open-source container orchestration platform that manages containerized applications across multiple hosts and provides automated deployment, scaling, and operations of application containers. Other orchestrators 128 include Docker Swarm, Apache Mesos, OpenStack, AWS CloudFormation, and Terraform.

The replicas 124 execute the microservice 122 that processes data from the data sources 130 and delivers it to the consumers 110. In some implementations, the replicas 124 are responsible for retrieving events from client-specific queues, processing the data, and delivering the processed events to corresponding consumers 110. These replicas are instantiated by the compute resource system 120 and managed by the orchestrator 128.

In an example implementation, each replica 124 is assigned a unique identifier and is aware of the total number of active replicas 124 in the system 100. This information allows the replicas to self-organize and efficiently distribute the workload among themselves without the need for centralized coordination. The replicas determine their individual processing sequences based on their unique identifiers and the total number of active replicas so that all data sources 130 are accessed and processed in a balanced manner.

As they process data, the replicas 124 monitor their own performance, including processing time and throughput. Based on this self-monitoring, replicas can request the orchestrator 128 to adjust the total number of active replicas, either by instantiating new replicas when the workload is high or terminating existing ones when the processing capacity exceeds the current demand. This dynamic scaling capability allows the system to maintain optimal performance and resource utilization under varying workload conditions. The replicas 124 also implement fault-tolerance mechanisms, allowing the system to continue functioning even if individual replicas fail, by dynamically redistributing the workload among the remaining active replicas.

When a new data source 130 is added, the orchestrator 128 detects this addition and broadcasts an update to all active replicas 124. Each replica 124 can then recalculate its processing sequence to incorporate the new data source 130. Likewise, if a data source 130 is removed, a similar process occurs so that the replicas 124 adjust their sequences to exclude the deleted source. To maintain balanced processing, the system may redistribute the workload among existing replicas 124 or adjust the replica count. The system 120 can also implement a periodic rebalancing mechanism that reassesses the distribution of data sources 130 among replicas 124, accounting for any cumulative changes over time.

An arbitrary example can be used to illustrate the scalability of the system. In a small-scale deployment, the system might manage 100 data sources with 5 replicas, each handling 20 sources within a 30-second window. As demand grows, it could scale to 1,000 data sources with 50 replicas, maintaining the same processing window. In a large enterprise setting, the system could handle 10,000 data sources using 500 replicas, each processing 20 sources every 30 seconds. For extreme scalability, a cloud-scale implementation could manage 100,000 data sources with 5,000 replicas. In this case, if the visitation frequency remains at 30 seconds, each replica would still only need to process 20 sources in that time frame.

In example implementations, the system can have the ability to dynamically adjust replica count based on overall system usage or performance. For instance, during peak hours, the system might spin up to 7,500 replicas to handle increased load, reducing processing time to 20 seconds per cycle. Conversely, during low-traffic periods, it could scale down to 2,500 replicas, allowing up to 60 seconds per cycle.

In example implementations, the system is designed to accommodate varying processing times for different queues, recognizing that in real-world scenarios, data complexity and volume can differ significantly across sources 130. To manage this variability, each replica 124 could maintain a rolling average of processing times for each queue it handles. If a particular queue consistently requires more time to process, the system can adjusts its strategy. For example, it may prioritize this queue by assigning it to replicas with lower overall workloads. Alternatively, it could allocate multiple replicas to process this queue in parallel, effectively distributing the workload.

The system may also implement an adaptive time slice allocation, where queues with historically longer processing times are given larger time slices within the processing window. To prevent slower queues from monopolizing resources, the system could employ a fair scheduling algorithm that ensures all queues receive attention, even if it means partially processing a complex queue and returning to it in the next cycle. Additionally, the system can trigger the creation of new replicas if it detects that varying processing times are causing overall delays in meeting the visitation frequency requirements.

In example implementations, the system can employ a multi-layered approach to ensure all queues are visited within the specified time frame, even as the number of queues and replicas increases. For example, a mechanism can provide a distributed timing protocol that synchronizes all replicas to a global clock. Each replica 124 could then maintain a local timer and a visit log for each queue it processes. As the system scales, it could dynamically adjust the number of replicas to maintain an optimal ratio of queues to replicas 124. The orchestrator 128 may continuously monitor the global visit logs and use predictive algorithms to anticipate processing time overruns. If it detects that certain queues are at risk of exceeding the visitation deadline, it can dynamically reassign queues to less burdened replicas or instantiate new replicas to share the load.

To handle extreme scaling scenarios, the system could implement a hierarchical oversight structure where replicas 124 are grouped into clusters, each managed by a sub-orchestrator. These sub-orchestrators coordinate to balance load across the entire system, enabling efficient management of many, e.g., hundreds of thousands, queues across many, e.g., thousands, of replicas.

In example implementations, the system can employ a ‘catch-up’ mechanism where any queues that miss their visitation window are flagged for priority processing in the next cycle, ensuring that no queue is consistently neglected even under high load conditions.

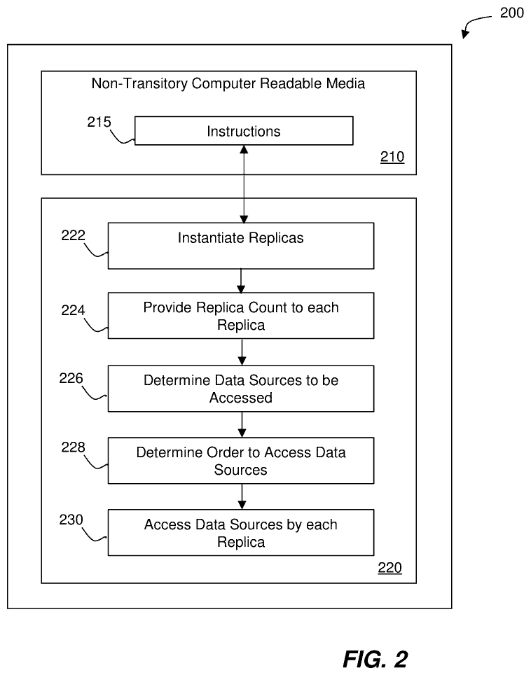

FIG. 2 provides one implementation of the compute resource system 120 that is configured to execute a plurality of microservices. In this example, compute resource system 120 comprises one or more processors, illustrated schematically by box 220, and memory, schematically illustrated by box 210. The memory stores instructions that, when executed by the one or more processors, cause the one or more processors to execute the processes described herein. Further description of the system is provided below.

In the example of FIG. 2, which can be understood along with the block diagram of FIG. 1, the compute resource system 120, e.g., via orchestrator 128, instantiates a plurality of replicas 124 for execution of the microservice 122 (step 222). Each replica 124 is provided with a replica count that indicates a quantity of replicas that are already executing the microservice (step 224). This replica count can be provided to each replica when that replica is instantiated.

Each replica 124 determines a number of data sources 130 that are to be accessed (step 226) and determines an order in which the data sources 130 will be accessed by that particular replica (step 228). The order is based on the replica count and the number of data sources 130 to be accessed. Each replica 124 will then access each of the data sources in the determined order (step 230).

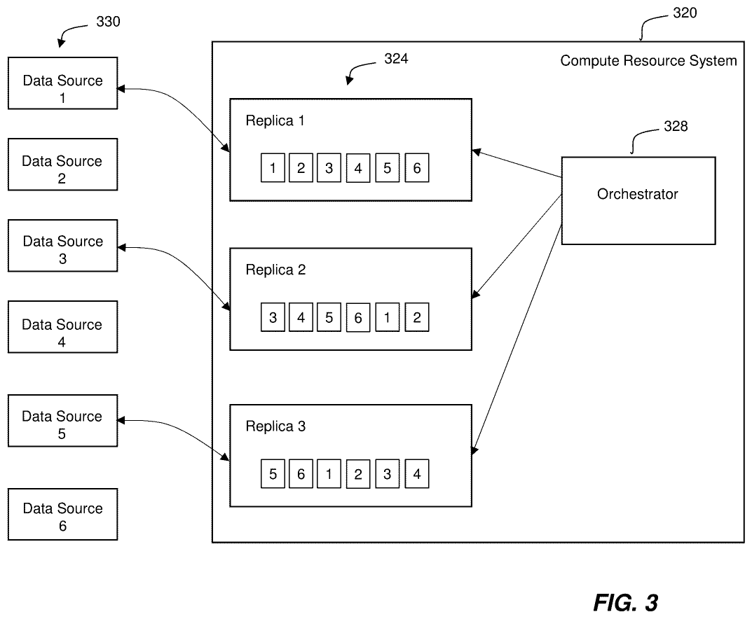

An example implementation of the process can be explained with reference to FIG. 3. In the example of FIG. 3, a compute resource system 320 is executing a micro service with three replicas 324. These replicas are accessing six data sources 330. It is noted that this particular example is provided only to illustrate an example of an implementation. It is understood that in practice a large number of replicas may access a large number of data sources, for example, in the hundreds of each.

As illustrated, a unique numerical identifier is assigned to each of the six data source 330, in this case sequential integers 1 to 6. As the orchestrator 328 instantiates each replica, it will indicate the number of other operating replicas. From this replica count, the replica will be assigned a replica number. For example, when the first replica is instantiated, the orchestrator indicates that there are no other replicas and, from this information, the replica determines it is replica 1. Similarly, when the second replica is instantiated, the orchestrator indicates that there is one replica already executing the microservice and the second replica determines it is replica 2. This process continues for each replica 324.

As such, each replica 324 receives information regarding a total number of active replicas and an identifier specific to that replica. Each replica 324 can then determine a starting data source or queue 330 based on the total number of active replicas and its own specific identifier. For example, the starting data source can be calculated using the formula:

$$Start Source = \frac{( Replica ID ) \times ( Number of Sources )}{( Number of Replicas )} - 1 ,$$

rounded to an integer. As an example for replica 2, the replica identifier is 2, the total number of data sources is 6, and the replica count is 3. The starting data source 330 for replica 2 would then be data source 3 (2*6=12; 12/3=4; 4−1=3).

It is noted that this formula is merely one way to identify the replicas 324 and data sources 330 and to determine the starting point for each replica. In general, each replica 324 can determine an order in which the data sources will be accessed based on the replica count and the number of data sources to be accessed. The precise manner of this determination can vary with a specific implementation.

Each replica 324 can the access each of the data sources 330 sequentially from the starting data source, wrapping around to the first data source in the list after accessing the last data source in the list. In this manner, no two replicas 324 will be accessing the same data source 330 at the same time. This technique helps to avoid collisions.

In addition, processing overhead can be limited because the orchestrator 328 was only required to provide the number of replicas, information that is typically already known. The orchestrator 328 can be unaware of the number of data sources (or queues) 330. The orchestrator 328 can managing allocation of the replicas 324, at least in part, based on information received from ones of the replicas 324.

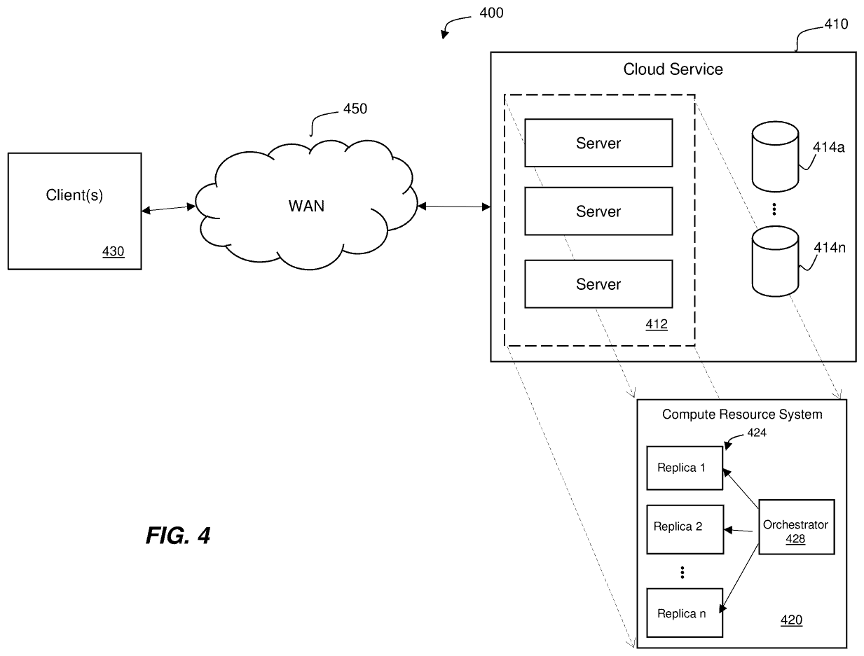

An example implementation is provided in FIG. 4, which illustrates a cloud-based implementation 400 of the system. As but one example, this system can be used for micro-batching. In this implementation, incoming data is grouped into small, manageable batches over short time intervals, typically ranging from a few seconds to a few minutes. These micro-batches are then processed together, allowing for more efficient use of computing resources compared to processing each data point individually, while still providing near-real-time results.

This implementation utilizes cloud service 410, which provides the infrastructure and resources used to run the system at scale. Within the cloud service 410, the compute resource system 420 represents the software layer where the core functionalities of the system are executed. This includes the orchestrator 428 and multiple replicas 424 (Replica 1, Replica 2, . . . , Replica n). These replicas 424 are instances of the microservice responsible for processing data.

The compute resource system 420 operates on the physical or virtualized hardware provided by the cloud service 410, represented by servers 412 and storage units 414a to 414n. These servers and storage units form the underlying infrastructure that supports the computational and data storage needs of the system. The entire cloud-based implementation is connected to clients 430 via a wide area network (WAN) 450, allowing for remote access and interaction with the system. The cloud-based implementation 400 encapsulates the logical components described in previous figures within a practical, scalable, and widely accessible infrastructure.

The clients 430 in FIG. 4 represent the end-users or systems that interact with the cloud service 410. These clients 430 encompass a wide range of entities, including end-user applications such as desktop, mobile, or web-based software that consume the processed data or events from the system. Enterprise systems that integrate with the cloud service to enhance their operations or decision-making processes also fall under this category. Additionally, third-party services or platforms can leverage the data processed by the cloud-based system 410, while IoT devices and smart sensors may both send data to and receive processed information from the system. Analytics platforms that consume the processed data for further analysis, reporting, or visualization are also considered clients in this context.

In this implementation, the clients 430 connect to the cloud service 410 via the wide area network 450, which could be the internet or a private network infrastructure. This network connection enables a variety of interactions between the clients and the system. Clients 430 can send requests or queries to the system, receive processed data or events from the replicas 424, and configure or manage their interaction with the system. In some cases, clients 430 may also act as publishers 150 (FIG. 1), sending data into the system for processing.

While the implementation of FIG. 4 shows the clients 430 being remote from the cloud service 410, it is understood that the clients 430 can also be executed by the cloud service 410. For example, each of the elements shown in FIG. 1 can be executed by the cloud service 410. In other implementations (not shown), some of all of the storage 414 can be remote from the cloud service 410, e.g., accessed by the wide area network 450 or otherwise.

The servers 412 of the cloud service 410 are typically high-performance, virtualized machines distributed across multiple data centers for redundancy and global reach. These servers 412 can be designed to be scalable and can be dynamically provisioned or de-provisioned based on the system's workload demands. The servers 412 host and execute the compute resource system 420, including the orchestrator 428 and the various replicas. They are equipped with powerful processors, ample RAM, and high-speed network interfaces to handle the intensive computational tasks of data processing, event routing, and client request handling. The servers 412 implement virtualization technologies, allowing multiple isolated instances of the system components to run concurrently, ensuring efficient resource utilization and providing a layer of abstraction from the underlying hardware.

The storage 414a to 414n components represent the distributed data storage system within the cloud service 410. This storage system 414 can be capable of handling large volumes of data with low-latency access. It may implement various storage technologies, including solid-state drives (SSDs) for high-performance data access and traditional hard disk drives (HDDs) for cost-effective bulk storage. The storage components 414 can be closely integrated with the servers 412, allowing for efficient data transfer and processing. The data sources and queues discussed here can be stored on the storage 414.

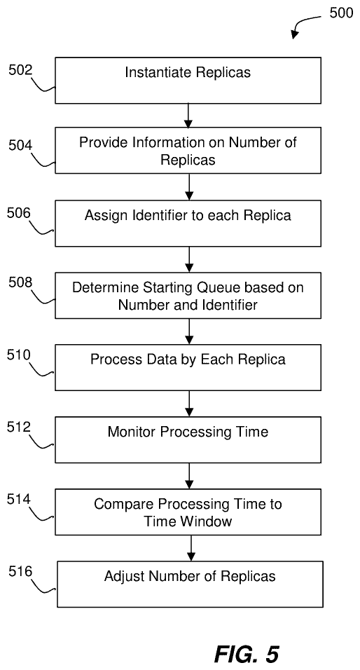

FIG. 5 provides a flow chart for a computer-implemented method for distributing workload in a cloud computing system such as the one shown in FIG. 4, as but one example. This method operates on a plurality of data sources, each comprising one or more queues. The illustrated method begins in step 502 by instantiating multiple replicas of a microservice, each designed to process data from the data sources. Each replica receives information including the total number of active replicas and an identifier specific to that replica (steps 504 and 506). Using this information, each replica determines its starting queue (step 508), creating a balanced distribution of work across the system.

The replicas can then process data from their determined starting queue and subsequent queues in a predefined order (step 510). For example, data is retrieved from the queues. The retrieved data is processed and the processed data is delivered to the appropriate client consumers.

To maintain optimal performance, the method can include a monitoring and adjustment mechanism. For example, a load balancing mechanism can dynamically adjust the number of data sources accessed by each replica based on a processing capacity of the replica, a current load on each data source, and a target access frequency for each data source. The load balancing mechanism periodically recalculates a distribution of data sources among replicas so that all data sources are accessed within a specified time frame.

In an example implementation, the system tracks the processing time for each replica to complete a full cycle through all queues (step 512) and compares this time to a predetermined time window (step 514). Based on this comparison, the system, e.g., via the orchestrator, can adjust the number of active replicas (step 516). The predetermined time window can be calculated considering the desired maximum time between visits to each queue and the total number of active replicas so that data processing is performed in a timely manner. The time window is fixed for all replicas. After completing a full cycle, each replica re-determines its starting queue based on any adjustments made to the number of active replicas.

In an example implementation, the adjustment of active replicas follows specific rules. For example, if the processing time exceeds the predetermined window, an additional replica is instantiated. If the processing time is significantly less than the window, a replica is removed. For example, the replica can be removed if the processing time is less than the predetermined time window by an amount determined by the number of replicas and the processing time, e.g., an amount of time where fewer replicas can access all of the data sources within the time window. The system maintains the same number of replicas if the processing time falls within an acceptable range relative to the predetermined window.

In an example implementation, to maintain strict window size timing, each replica implements a timer that starts when it begins processing its assigned data sources. For example, a configurable parameter can set a desired time window. At the end of each processing cycle, the elapsed time is checked against the desired time window. If a replica finishes processing before the time expires, it calculates the remaining time and implements a sleep or wait function for this duration before starting its next cycle. Conversely, if a replica doesn't finish within the desired time window it sets a flag indicating the window was exceeded, completes the current cycle, and sends a message to the orchestrator requesting an additional replica.

In an example implementation, the orchestrator may use a threshold (e.g., if >50% of replicas report exceeding the window) to decide when to spawn a new replica. For adaptive adjustment, each replica maintains a rolling average of processing times. If this average consistently falls below a certain threshold of the desired time window, the replica suggests to the orchestrator that a replica could be removed. As an example, a lightweight synchronization protocol can allow replicas to share their current state at the end of each cycle, enabling dynamic adjustments to starting points and detection of neglected data sources. These mechanisms can allow the system to maintain desired timing characteristics while adapting to changing loads and conditions.

In an example implementation, a configuration parameter providing a queue visitation frequency can be used to specify how often each queue needs to be accessed. For example, the system may be configured to ensure that every queue is visited at least once every 30 seconds. The time window for processing can then be calculated based on this visitation frequency and the total number of queues. This time window could then be used to determine the number of replicas needed and, perhaps, to regulate the processing speed of each replica.

As discussed above, the orchestrator manages the allocation of replicas and provides each with its specific identifier, e.g., with information for the replica to determine its own identifier. The orchestrator operates without knowledge of the number of data sources and queues, relying on information received from the replicas themselves. The order of the queues to be processed sequentially is determined by the replicas in a manner in which each replica's starting point is offset from the first queue based on its specific identifier so that the queues can be accessed with fewer collisions. This decentralized design can help to implement a scalable system with less overhead than a system where the orchestrator instructs each replica as to which queue to access at a given time.

The method associates each queue with a specific client. The process of handling data from a queue involves delivering the stored events to the associated client, completing the data flow from source to end-user in the cloud computing system.

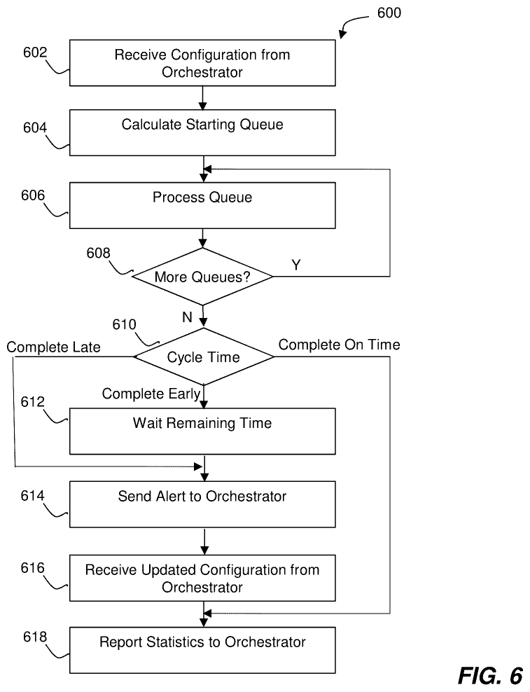

FIG. 6 provides a flowchart 600 illustrating the decision-making process of a single replica as it processes data and interacts with the orchestrator for an example implementation. This flowchart illustrates how a single replica operates autonomously while still coordinating with the larger system through the orchestrator. At the start, the replica is initialized.

In step 602, the replica receives configuration information from the orchestrator. This information can include the number of active replicas, the replica's unique identifier, a time window for processing cycle, and a queue visitation frequency requirement. From this information, a starting queue can be calculated based on the configuration information (step 604).

The queues are processed by the replica beginning in step 606. To begin a start timer can be initiated for the processing window. The current queue can then be processed, e.g., by retrieving data from the queue, processing the data, and optionally updating a visit log for the queue. The processing continues until all queues have been processed (step 608).

Upon completion of the processing, the replica can check the cycle completion time, i.e., how long it took to completing the processing in steps 606 and 608. This is illustrated as step 610. To accomplish this the elapsed time can be compared to the configured time window. If the cycle completed early, the replica can wait for remaining time (step 612) and alert the orchestrator (step 614). If the cycle completed late, the replica can alert the orchestrator to report that the time window has been exceeded and request additional replica if threshold met. In either of these cases, the orchestrator might provide updated configuration information (step 616). In any case, the replica can report the timing statistics to the orchestrator (step 618). For example, the replica can report processing times for each queue and any queues that were not visited.

Throughout this process, the replica might be constantly listening for messages from the orchestrator. As examples, the messages might include instructions to adjust processing speed, updates on the total number of replicas or queues, or commands to shut down or handover queues to other replicas.

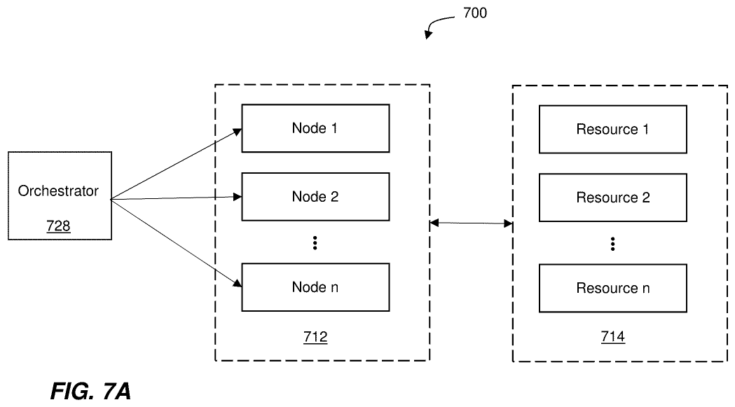

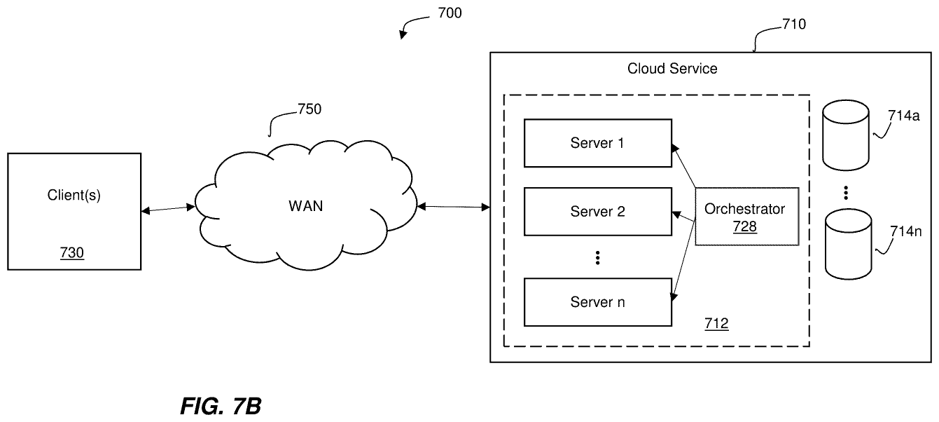

FIG. 7A illustrates another implementation. As shown by this figure, concepts disclosed herein can be implemented in contexts other than microservices. The system 700 includes a plurality of nodes 712 (Node 1, Node 2, . . . , Node n) and a plurality of compute resources 714 (Resource 1, Resource 2, . . . , Resource n). An orchestrator 728 can be used to manage allocation of ones of the compute resources 714 for concurrent use by the nodes 712.

Similar to the implementation of FIG. 4, the system 700 can be implemented as a cloud service as shown in FIG. 7B. For example, one or more clients 730 can access the cloud service via a wide area network 750. As with the other implementations, it is understood that the clients can be part of the cloud service or that some of the nodes 712 or compute resources 714 can be accessed by the wide area network 750 or by other means, e.g., local area network.

The nodes 712 can be implemented by various entities such as physical servers housed in data centers and virtual machines that emulate physical computers in software. The nodes 712 can include containers, which are lightweight, isolated environments for running applications. Edge devices can include IoT (internet of things) sensors or local servers that process data near its source. Even serverless function instances, which are ephemeral compute units designed to run specific functions, can be considered nodes 712 in certain contexts.

The 712 nodes can interact with and utilize a diverse set of compute resources 714. Compute resources 714 can include CPU (central processing unit) cores, GPU (graphical processing unit), and memory (e.g., RAM). The compute resources 714 can include storage resources based on various technologies, such as hard disk drives and solid-state drives, as well as cloud-specific solutions like object and block storage. Networking resources, including bandwidth, IP addresses, and load balancers, enable communication and data transfer. Database resources, both relational and NoSQL, along with in-memory options, provide data storage and retrieval capabilities. As discussed above, the compute resources 714 comprise data sources and the nodes 712 comprise replicas of a microservice.

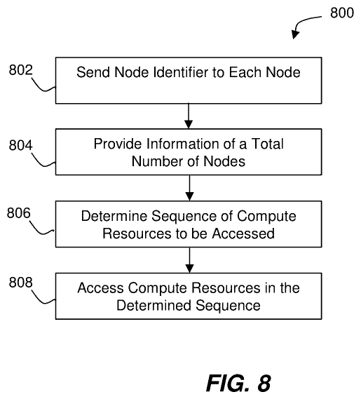

An example implementation of the system 700 can be described with reference to the flow chart 800 of FIG. 8. The orchestrator 728 is configured to send a node identifier to each node 712 (step 802) as well as information providing a total number of nodes accessing the ones of the compute resources (step 804). Each node 712 is configured to determine a sequence of compute resources 714 to access based on the node identifier of that node and the total number of nodes accessing the compute resources 714 (step 806). The determined sequence can be a sequential order of compute resource identifiers.

Each node 712 is configured to access ones of the compute resources 714 in the determined sequence (step 808). For example, each node 712 will start at a compute resource 714 with an identifier offset from a starting resource of the other nodes. As above, the orchestrator 728 does not need to be unaware of the number of compute resources 714. It can manage allocation of the compute resources 714, at least in part, based on information received from ones of the nodes 712.

Details discussed above can also be applied to the implementation of FIGS. 7 and 8. For the sake of simplicity, each combination and permutation of the various examples and implementations has not been explicitly discussed. It is understood that features of the various implementations can be utilized in other implementations.

Implementations can be useful in a number of contexts. For high-throughput scenarios, such as real-time analytics in financial markets, the system could implement a predictive queue assignment algorithm. This would use machine learning to anticipate data influxes and preemptively allocate more replicas to soon-to-be-busy queues. In contrast, for systems with more predictable, cyclical workloads like daily batch processing jobs, the replica count could be preset to scale up and down at specific times, optimizing resource usage.

For edge computing applications, where network connectivity may be intermittent, the system could be modified to operate in a more autonomous mode. Replicas could make decisions locally based on pre-set rules, synchronizing with the central orchestrator only when connections are available. This would enable the system to function effectively in remote or mobile scenarios.

In ultra-large-scale deployments, such as global CDNs (content delivery networks) or IoT (internet of things) networks, a hierarchical orchestration model could be implemented. This would involve multiple layers of sub-orchestrators, each managing a geographical or logical subset of the entire system. This approach would improve scalability and reduce the load on any single orchestrator.

For use cases requiring strict data sovereignty or security, the system could incorporate data-aware routing. Replicas would be tagged with security clearances or geographical restrictions, ensuring that sensitive data is only processed by appropriate replicas. This would enable the system to maintain compliance with regulations like GDPR (general data protection regulation) while still leveraging its distributed nature.

In scenarios with highly variable queue processing times, such as in heterogeneous computing environments, the system could implement a more sophisticated load balancing algorithm. This could involve real-time profiling of queue complexity and dynamic adjustment of replica assignments, ensuring that complex queues don't bottleneck the entire system.

For applications requiring extremely low latency, like online gaming or autonomous vehicle networks, the system could be optimized to prioritize speed over perfect load distribution. This might involve allowing some redundancy in queue processing to ensure the fastest possible response times.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented system comprising:
a plurality of data sources;
a compute resource system configured to execute a plurality of microservices, the compute resource system comprising one or more processors and memory storing instructions that, when executed by the one or more processors, cause the one or more processors to:
instantiate a plurality of replicas for execution of the microservice;
provide, to each replica, a replica count indicating a quantity of replicas that are already executing the microservice, the replica count being provided to each replica when that replica is instantiated;
determine, by each replica, a number of data sources to be accessed;
determine, by each replica, an order in which the data sources will be accessed, the order based on the replica count and the number of data sources to be accessed; and
access, by each replica, each of the data sources in the determined order.

2. The system of claim 1, wherein the quantity of replicas is determined by a time window during which each replica accesses each of the data sources, the time window being fixed for all replicas.

3. The system of claim 1, wherein the instructions further cause the one or more processors to:
monitor a processing time for each replica to complete accessing all of the determined data sources;
compare the processing time to a predetermined time threshold; and
adjust the number of replicas based on a result of the compare.

4. The system of claim 1, wherein the instructions cause the one or more processors to cause each replica to access each of the data sources by:
assigning a unique numerical identifier to each data source, the numerical identifiers comprising sequential integers used to order the data sources in a list from first to last;
calculating a starting data source for each replica using the formula:
$$Start Source = \frac{( Replica ID ) \times ( Number of Sources )}{( Number of Replicas )} - 1 ,$$
rounded to an integer; and
for each replica, accessing each of the data sources sequentially from the starting data source, wrapping around to the first data source in the list after accessing the last data source in the list.

5. The system of claim 1, wherein each data source comprises one or more queues associated with specific clients, and the instructions further cause the one or more processors to:
retrieve data from the one or more queues;
process the retrieved data; and
deliver the processed data to corresponding client consumers.

6. The system of claim 1, wherein the instructions further cause the one or more processors to implement a load balancing mechanism that dynamically adjusts the number of data sources accessed by each replica based on a processing capacity of the replica, a current load on each data source, and a target access frequency for each data source, the load balancing mechanism periodically recalculating a distribution of data sources among replicas so that all data sources are accessed within a specified time frame.

7. A computer-implemented method for distributing workload in a cloud computing system that includes a plurality of data sources, each data source comprising one or more queues, the method comprising:
instantiating a plurality of replicas of a microservice, each replica configured to process data from the data sources;
receiving, at each replica, information regarding a total number of active replicas and an identifier specific to that replica;
determining, by each replica, a starting queue based on the total number of active replicas and the specific identifier; and
processing, by each replica, data from its determined starting queue and subsequent queues in a predefined order.

8. The method of claim 7, further comprising:
monitoring a processing time for each replica to complete a full cycle through all queues;
comparing the processing time to a predetermined time window; and
adjusting the number of active replicas based on a result of the comparing.

9. The method of claim 8, wherein the predetermined time window is calculated based on a desired maximum time between visits to each queue and the total number of active replicas.

10. The method of claim 8, further comprising, after completing a full cycle through all queues, re-determining the starting queue for each replica based on the adjusted number of active replicas.

11. The method of claim 8, wherein adjusting the number of active replicas comprises:
instantiating an additional replica in response to determining that the processing time exceeds the predetermined time window;
removing a replica in response to determining that the processing time is less than the predetermined time window by an amount determined by the number of replicas and the processing time; and
keeping the same number of replicas in response to determining that the processing time does not exceed the predetermined time window and also that the processing time is not less than the predetermined time window by the determined amount.

12. The method of claim 7, wherein the identifier specific to each replica is provided by an orchestrator that is unaware of the number of data sources and queues, the orchestrator managing allocation of replicas, at least in part, based on information received from ones of the replicas.

13. The method of claim 7, wherein the predefined order is a sequential order of queue identifiers, and each replica's starting queue is offset from a first queue by a number determined from the identifier specific to that replica.

14. The method of claim 7, further comprising:
detecting a failure of one of the replicas; and
continuing to process data from all queues using the remaining active replicas without reassigning queue responsibilities.

15. The method of claim 7, wherein each queue is associated with a specific client and wherein processing data from a queue comprises delivering events stored in the queue to the associated client.

16. A system for distributing workload in a cloud computing environment, comprising:
a plurality of data sources, each data source comprising one or more queues;
an orchestrator; and
a plurality of replicas of a microservice;
wherein the system is configured to perform the method of claim 7.

17. A computer-implemented system comprising:
a plurality of nodes;
a plurality of compute resources; and
an orchestrator configured to manage allocation of ones of the compute resources for concurrent use by the nodes, wherein the orchestrator is configured to:
send a node identifier to each node;
send, to each node, information providing a total number of nodes accessing the ones of the compute resources;
wherein each node is configured to:
determine a sequence of compute resources to access based on the node identifier of that node and the total number of nodes accessing the compute resources;
access the ones of the compute resources in the determined sequence.

18. The system of claim 17, wherein, for each node, the determined sequence is a sequential order of compute resource identifiers, and each node starts at a compute resource with an identifier offset from a starting compute resource of the other nodes.

19. The system of claim 17, wherein the orchestrator that is unaware of the number of compute resources, the orchestrator managing allocation the ones of the compute resources, at least in part, based on information received from ones of the nodes.

20. The system of claim 17, wherein the compute resources comprise data sources and the nodes comprise replicas of a microservice.
